(19) United States
(12) Patent Application Publication
(10) Pub. No.: US 2004/0047392 A1
(43) Pub. Date: Mar. 11, 2004

(54) Apparatus for measuring ear and forehead temperature

(76) Inventors: Shu-Mei Wu, Taipei (TW); Yao Ou-Yang, Junghe City (TW); Xing Ou-Yang, Junghe City (TW); Chao-Wang Chen, Taipei (TW)

Correspondence Address: KAO H. LU, 686 LAWSON AVE, HAVERTOWN, PA, 19083, US

(21) Appl. No.: 10/235,716

(22) Filed: Sep. 6, 2002

(51) Int. Cl. G01J 5/00

(52) U.S. Cl. 374/121

(57) ABSTRACT

An apparatus for measuring ear and forehead temperature, in which an accessory is added in a traditional infrared ear thermometer allowing the measurement of heat radiation emitted from the forehead. The measurement modes can be automatically or manually switched, and the measurement results can be converted into corresponding temperature figures readable to users.

### BACKGROUND OF THE INVENTION

1. Field of the Invention

The invention relates generally to an apparatus for measuring ear and forehead temperature; and more particularly, the invention relates to an accessory added in a traditional ear thermometer, allowing which to measure the ear and/or forehead temperature that reflects the temperature of human brain sensorium.

2. Related Art of the Invention

Currently, mercury thermometer, electronic thermometer and infrared ear thermometer are the tools commonly used to measure body temperature of human beings. The mercury and electronic thermometers are suitable for measuring oral, rectal and underarm temperature. However, as the mercury thermometer is operated based on contact thermo-equilibrium, a longer measuring time is normally required. The electronic thermometer predicts the thermo-equilibrium temperature from the temperature variation within a short period of time. The ear thermometer uses a sensor to detect the infrared beam of the heat radiation source and convert the measurement result into temperature in a very short time. However, such non-contact type temperature measuring apparatus can only provides accurate measurement result under the certain external conditions. As the ear is close to the heat source of human brain, and the internal ear structure prevents the dissipated heat radiation from being interfered. Therefore, the ear thermometer gives great convenience for measuring body temperature. For measuring ear temperature, the probe of the ear thermometer is inserted into the ear and the measurement button is pushed. The measurement result can be obtained within seconds. The ear thermometer is thus more and more popular.

The infrared temperature measuring apparatus still has certain drawback in certain aspect. Although the measurement principle of the infrared temperature measurement apparatus is not limited to the area to be measured, the application of the ear thermometer cannot be used external to ear. That is, there is no guarantee that the measurement obtained from area other than ear can be used as a reference. Further, even if a temperature is measured, the user cannot determine what the measured temperature stands for. The limitation of ear thermometer includes the inapplicability when the ear is injured. Other factors may also cause the ear thermometer inapplicable. It is thus necessary and advantageous if the traditional ear thermometer can provide accurate temperature measurement when the ear thermometer is inapplicable.

### SUMMARY OF THE INVENTION

The present invention provides an infrared temperature measurement apparatus applicable for measuring temperature of two different areas such as ear and forehead. The infrared temperature measurement apparatus can be switched between the modes of ear temperature measurement and the forehead temperature measurement. The measurement results are then converted into the corresponding temperature values for the user to read.

In one aspect, the present invention provides an infrared temperature measurement apparatus applicable to measure heat radiation of ear and forehead. The infrared temperature measurement apparatus has a collecting cap capping a probe of a traditional ear thermometer. At the bulk capped with the collecting cap, a switch is installed to automatically switch on the forehead temperature measurement mode after the collecting cap is mounted on the probe; and to switch on the ear temperature measurement mode when the collecting cap is removed from the probe. The automatic switching function between the forehead and ear temperature measurement can also be replaced by manual control by adding an additional switch button or using the existing button. According to the installation of the collecting cap, the user can switch the required mode to measure.

In another aspect, the present invention provides a collecting cap which can be mounted on the probe of a traditional ear thermometer, allowing the user to measure the body temperature at an area other than the ear. The collecting cap includes a collecting window to contact with the area to be measured. The area includes the forehead, preferably. Thereby, a certain distance between the infrared probe and the heat radiation emitted from the area to be measured is maintained, and the interference from other heat radiation source is insulated. That is, the infrared probe measures only the heat radiation received by the collecting window. The measurement results are then converted into temperature value readable to the user. The user can also compare the ear measured temperature and forehead temperature to convert the forehead measurement result into readable temperature value. For example, the ear temperature can be measured by removing the collecting cap from the probe first. The measurement mode is then automatically or manually switched to forehead measuring mode after the collecting cap is capped on the probe. The internal calculation unit then converts the measurement results into temperature values shown on a display. When the collecting cap is fabricated as a functional upgrade device of the ear thermometer, an additional lookup table may be attached allowing the user to check corresponding temperature of the readings shown on the display.

### BRIEF DESCRIPTION OF THE DRAWINGS

These, as well as other features of the present invention, will become more apparent upon reference to the drawings wherein:

FIG. 1 shows a conventional infrared ear thermometer;

FIG. 2 shows an apparatus that can be mounted on an infrared ear thermometer;

FIGS. 3A and 3B shows the local enlargement of a probe with automatic mode switch; and

FIGS. 4A and 4B shows the probe as shown in FIG. 3A capped with the collecting cap as shown in FIG. 2.

### DETAILED DESCRIPTION OF THE PREFERRED EMBODIMENT

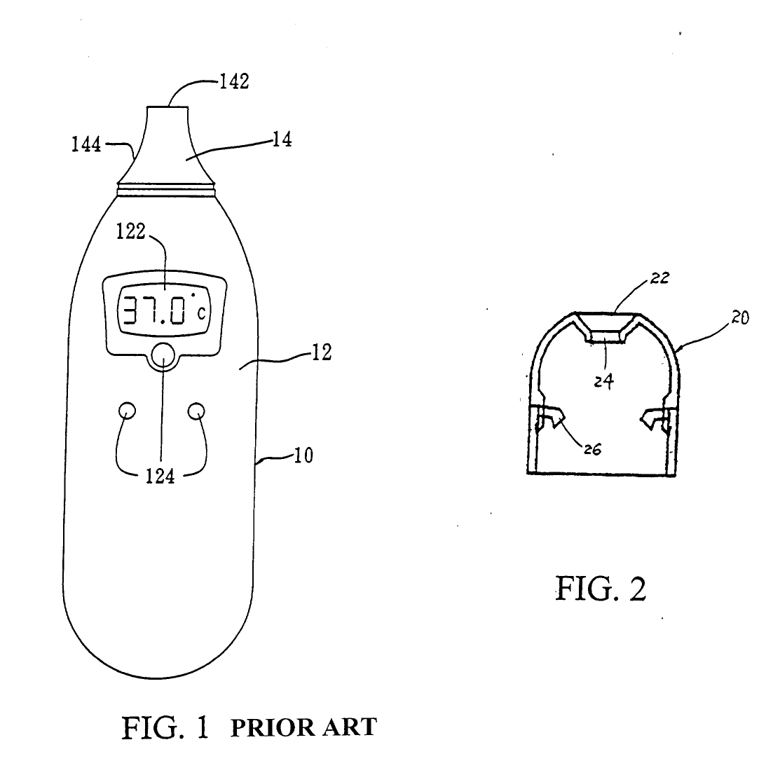

FIG. 1 shows an ear thermometer. The infrared ear thermometer 10 includes a bulk 12 and a probe 14 formed integrally. The probe has the geometry suitable for being disposed in a human ear. The tip 142 of the probe includes a transparent window. The heat radiation emitted from the human ear is transmitted into the sensor (not shown) installed in the probe 14 via the transparent window 142. The rest surface 144 of the probe 14 is made of heat insulating material. The technique for the probe 14 is known to the art. The bulk 12 comprises a liquid crystal display 122 and several buttons 124. By switching on one of the buttons 124, the power supply is provided. By operating a functional key and activating a measuring key, the temperature is measured in a short time and displayed on the liquid crystal display 122. The measurement and conversion of the measurement are also known to the art.

FIG. 2B shows a collecting cap 20. The collecting cap 20 includes a collecting window 22, a frame 24 and several frames supporting elements 26. The collecting window 22 is made of a material transparent to heat radiation. By directly contacting the collecting window 22 to an area such as the forehead, the heat radiation emitted therefrom is collected. The frame 24 and the frame supporting elements 26 are mounted on the ear thermometer 10. By pressing the frame 24 towards the probe 14, the geometry of the probe 14 allows the frame 24 to tightly hold the probe 14 therein. With the assistance of the frame supporting elements 26, the collecting cap 20 can be combined with the ear thermometer 10.

To provide two different measuring modes, for example, an ear temperature measurement mode and a forehead temperature measurement mode, the ear thermometer 10 includes a switch button 124. By manually operating the button 124, the user can select between the ear and the forehead temperature measurement modes. The corresponding temperature of the measurement result for the selected measurement mode is calculated by a built-in circuit and displayed on the liquid crystal display 122. The temperature reading obtained from the ear temperature measurement mode is the same as that obtained from the forehead temperature measurement mode. Such temperature reading is those scale that normal user can use as a reference to realize the physical condition the human body. Both the ear and forehead temperature measurement results allow user to read easily. As a result, an additional option for measurement body temperature is provided.

When the above ear thermometer 10 is not integrated with the collecting cap 20, a lookup table can be attached allowing the user to find the corresponding temperature of a measurement result obtained from certain measurement mode. For example, when the collecting cap 20 is provided as an accessory of the ear thermometer 10, one can use the lookup table to obtain the corresponding temperature measured by using the collecting cap 20.

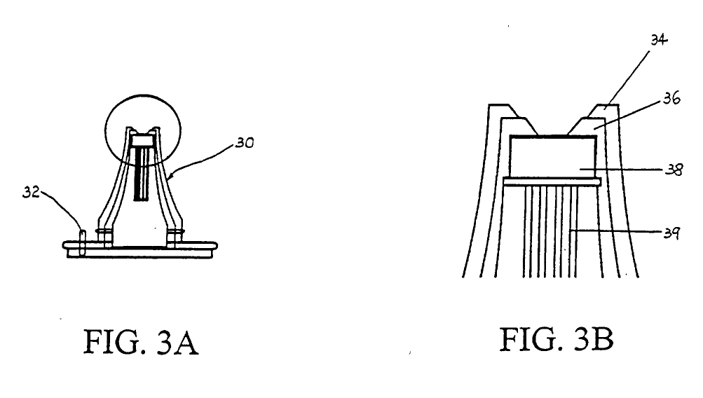

The manual switch between different measurement modes can be replaced by automatic switch. Referring to FIGS. 3A and 3B, the external and internal designs of the probe 30 of the thermometer employing the collecting cap 20 are shown. The probe includes a touch switch 32. When the switch 32 is activated, the internal circuit design allows the thermometer switched between different measurement modes according to whether the collecting cap 20 is mounted. Before the activate switch 32 is pressed, the ear temperature mode is selected. After the collecting cap 20 is mounted, the frame supporting elements 24 presses down the switch 32, such that the forehead temperature mode is automatically selected. As shown in FIGS. 3A and 3B, the structure of the probe 30 includes an outer layer covered with a plastic enclosure 34, a metal element 36 for heat dissipation, and a sensor 38 disposed in the metal element 36. The heat radiation detected by the sensor 38 is converted into a signal transmitted to the internal circuit (not shown) via the wiring 39. In the present invention, the probe 30 includes an additional switch 32. The probe does not require a waveguide tube therein. Instead, the sensor directly receives the heat radiation, which is then converted into the corresponding signal transmitted to the internal circuit.

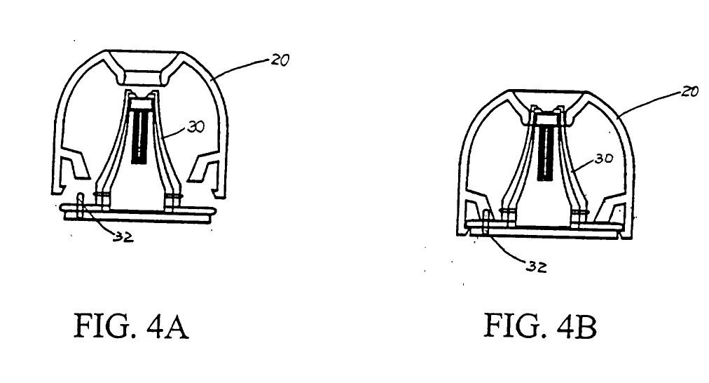

Referring to FIGS. 4A and 4B, the infrared thermometer having the probe as shown in FIG. 3A with and without the collecting cap 20 as shown in FIG. 2 is mounted thereon is shown. FIGS. 4A and 4B correspond to similar condition after the collecting cap 20 is mounted to the ear thermometer 10. The difference includes that the switch 32 is trigger to activate the mode switch when the frame supporting elements 26 is pressed towards the probe 30. In FIG. 4B, the collecting cap 20 allows the infrared probe 30 keeping a constant distance from the area to be measured and isolating other heat radiation interference. That is, only the heat radiation within the collecting window 22 is collected. The stable heat radiation source can thus be obtained.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. An infrared thermometer, having a first measurement mode for measuring a first area and a second measurement mode for measuring a second area, comprising:
a probe, operative to perform measurement in the first measurement mode by contacting the first area, the probe including a sensor to receive heat radiation emitted from the first area and the second area;
a collecting cap, capping the probe therein to contact the second area, so as to perform measurement in the second measurement mode; and
a switch, switching between the first and second measurement modes according to whether the collecting cap is mounted to the probe.

2. The infrared thermometer according to claim 1, wherein the collecting cap further comprises a collecting window to contact the second area, the sensor receives heat radiation of the second area with a distance within coverage of the collecting window only.

3. The infrared thermometer according to claim 1, wherein the collecting cap further comprises a frame mounted on the probe and a plurality of frame supporting elements mounted on the probe for capping the collecting cap on the probe.

4. The infrared thermometer according to claim 1, wherein the first area includes a human ear and the second area includes a human forehead.

5. The infrared thermometer according to claim 1, wherein measurements results for the first measurement mode and the second measurement mode performed for the same period of time are the same.

6. The infrared thermometer according to claim 1, wherein the first measurement mode is automatically switched to the second measurement mode when the collecting cap is mounted on the probe.

7. The infrared thermometer according to claim 1, wherein the first measurement mode is manually switched to the second measurement mode when the collecting cap is mounted on the probe.

8. An apparatus that can be capped on a probe of an ear thermometer, allowing the ear thermometer to measure ear temperature and skin temperature at an area other than the ear, the apparatus comprising:
a collecting window, to contact with an area to be measured, such that a sensor of the ear thermometer is kept at a distance from the area to measure heat radiation emitted therefrom, and heat radiation interference from other source is insulated, such that only heat radiation emitted within the range of the collecting window is received; and
a frame, mounted on the probe of the ear thermometer.

9. The apparatus according to claim 8, further comprising a plurality of frame supporting elements mounted close to the probe of the ear thermometer allowing the apparatus firmly holding the probe therein.

10. The apparatus according to claim 8, wherein the area to be measured includes human forehead.
